(19) United States
(12) Patent Application Publication
(10) Pub. No.: US 2016/0073322 A1
(43) Pub. Date: Mar. 10, 2016

(54) Proximity Service Authorization Method, Apparatus, and System

(71) Applicant: Huawei Device Co., Ltd., Shenzhen (CN)

(72) Inventors: Chenliang Gao, Shenzhen (CN); Hui Jin, Beijing (CN); Guowei Ouyang, Beijing (CN)

(21) Appl. No.: 14/943,778

(22) Filed: Nov. 17, 2015

Related U.S. Application Data
(63) Continuation of application No. PCT/CN2014/077656, filed on May 16, 2014.

(30) Foreign Application Priority Data
May 20, 2013 (CN) 201310188604.9

(51) Int. Cl. H04W 40/24; H04W 8/20; H04W 12/08; H04W 4/00

(52) U.S. Cl. CPC H04W 40/246; H04W 4/008; H04W 8/205; H04W 8/20; H04W 12/08

(57) ABSTRACT

A proximity service authorization method, an apparatus, and a system. A first network-side entity receives a first request message sent by first user equipment, where the first request message includes identity information of the first user equipment and an application identifier; and it is determined, at least according to acquired proximity service configuration data of the first user equipment, that the first user equipment can perform a proximity service corresponding to the application identifier. In this way, a first proximity service server authorizes and authenticates two user equipment that require a proximity service.

### CROSS-REFERENCE TO RELATED APPLICATIONS

This application is a continuation of International Application No. PCT/CN2014/077656, filed on May 16, 2014, which claims priority to Chinese Patent Application No. 201310188604.9, filed on May 20, 2013, both of which are hereby incorporated by reference in their entireties.

### TECHNICAL FIELD

Embodiments of the present disclosure relate to the field of communications technologies, and in particular, to a proximity service authorization method, an apparatus, and a system.

### BACKGROUND

In a mobile communications network, data communication between user equipment needs to be performed through a core network entity, such as a serving gateway (SGW)/packet data network gateway (PGW). Therefore, higher network transmission bandwidth is required by the core network entity, leading to a heavier network transmission burden of the core network entity. Even if data needs to be transmitted between two user equipment that are close to each other, transmission still needs to be performed using a core network, resulting in lower transmission efficiency.

Currently, in order to reduce the network transmission burden of the core network entity, a proximity services (ProSe) processing method is used, such that two user equipment that are close to each other can directly perform data communication without a need to perform data communication using the core network entity, and the transmission efficiency can be improved.

However, in an existing proximity service implementation process and method, a ProSe server does not need to authorize and authenticate user equipment using a proximity service; as a result, the ProSe server cannot properly control a proximity service of user equipment of a mobile terminal, and therefore, service quality of the proximity service of the user equipment cannot be ensured.

### SUMMARY

The present disclosure provides a proximity service authorization method, an apparatus, and a system, which are used to resolve the following problem in an existing proximity service authorization method. Because a proximity service server does not need to authorize and authenticate user equipment using a proximity service, the proximity service server cannot properly control a proximity service of user equipment of a mobile terminal, and therefore, service quality of the proximity service of the user equipment cannot be ensured.

According to a first aspect, a proximity service authorization method is provided, including receiving, by a first network-side entity, a first request message sent by first user equipment, where the first request message includes identity information of the first user equipment and an application identifier; and determining, at least according to acquired proximity service configuration data of the first user equipment, that the first user equipment can perform a proximity service corresponding to the application identifier.

Based on the first aspect, in a first possible implementation manner, the acquiring proximity service configuration data of the first user equipment includes receiving, by the first network-side entity, first information sent by the first user equipment, where the first information includes one or more of the following: whether the first user equipment is allowed to discover, be discovered, perform proximity service communication, and a range of proximity service communication of the first user equipment.

Based on the first aspect, in a second possible implementation manner, the acquiring proximity service configuration data of the first user equipment includes receiving, by the first network-side entity, second information of a first user equipment sent by a second network-side entity, where the second information includes one or more of the following: whether the first user equipment is allowed to discover, be discovered, perform proximity service communication, a range of proximity service communication of the first user equipment, whether the first user equipment is allowed to perform a proximity service across a public land mobile network (PLMN), whether the first user equipment is allowed to perform a proximity service in a visited public land mobile network (VPLMN), and whether the first user equipment is allowed to perform a public safety proximity service.

Based on the first or second possible implementation manner of the first aspect, in a third possible implementation manner, the range of proximity service communication of the first user equipment includes an identifier of an application, of the first user equipment, that can use a proximity service.

Based on the first aspect or any one of the first to the third possible implementation manners of the first aspect, in a fourth possible implementation manner, if the first user equipment is allowed to perform a proximity service in a VPLMN, and the first network-side entity is a network-side entity of the VPLMN, the acquiring proximity service configuration data of the first user equipment includes sending, by the first network-side entity, a second request message to a third network-side entity, where the second request message includes the identity information of the first user equipment, such that the third network-side entity sends the proximity service configuration data of the first user equipment to the first network-side entity according to the second request message.

Based on the first aspect or any one of the first to the third possible implementation manners of the first aspect, in a fifth possible implementation manner, the first request message further includes identity information of second user equipment, and the first user equipment and the second user equipment do not belong to a same PLMN; and after the receiving, by a first network-side entity, a first request message sent by first user equipment, the method further includes determining, by the first network-side entity at least according to the acquired proximity service configuration data of the first user equipment, that the first user equipment can perform a cross-PLMN proximity service corresponding to the application identifier.

According to a second aspect, a proximity service authorization method is provided, including sending, by first user equipment, a first request message to a first network-side entity, where the first request message includes identity information of the first user equipment and an application identifier, such that the first network-side entity determines, at least according to acquired proximity service configuration data of the first user equipment, that the first user equipment can perform a proximity service corresponding to the application identifier; and after the first network-side entity determines that the first user equipment can perform the proximity service corresponding to the application identifier, performing, by the first user equipment, the proximity service corresponding to the application identifier.

Based on the second aspect, in a first possible implementation manner, the proximity service configuration data of the first user equipment includes one or more of the following: whether the first user equipment is allowed to discover, be discovered, perform proximity service communication, a range of proximity service communication of the first user equipment, whether the first user equipment is allowed to perform a proximity service across a PLMN, whether the first user equipment is allowed to perform a proximity service in a VPLMN, and whether the first user equipment is allowed to perform a public safety proximity service. The range of proximity service communication of the first user equipment includes an identifier of an application, of the first user equipment, that can use a proximity service.

According to a third aspect, a first network-side entity is provided, including a receiving module configured to receive a first request message sent by first user equipment, where the first request message includes identity information of the first user equipment and an application identifier; an acquiring module configured to acquire proximity service configuration data of the first user equipment; and a determining module configured to determine, at least according to the acquired proximity service configuration data of the first user equipment, that the first user equipment can perform a proximity service corresponding to the application identifier.

Based on the third aspect, in a first possible implementation manner, the acquiring module is further configured to receive first information sent by the first user equipment, where the first information includes one or more of the following: whether the first user equipment is allowed to discover, be discovered, perform proximity service communication, and a range of proximity service communication of the first user equipment.

Based on the third aspect, in a second possible implementation manner, the acquiring module is further configured to receive second information of a first user equipment sent by a second network-side entity, where the second information includes one or more of the following: whether the first user equipment is allowed to discover, be discovered, perform proximity service communication, a range of proximity service communication of the first user equipment, whether the first user equipment is allowed to perform a proximity service across a PLMN, whether the first user equipment is allowed to perform a proximity service in a VPLMN, and whether the first user equipment is allowed to perform a public safety proximity service.

Based on the first or second possible implementation manner of the third aspect, in a third possible implementation manner, the range of proximity service communication of the first user equipment includes an identifier of an application, of the first user equipment, that can use a proximity service.

Based on the third aspect or any one of the first to the third possible implementation manners of the third aspect, in a fourth possible implementation manner, if the first user equipment is allowed to perform a proximity service in a VPLMN, and the first network-side entity is a network-side entity of the VPLMN, the acquiring module is further configured to send a second request message to a third network-side entity, where the second request message includes the identity information of the first user equipment, such that the third network-side entity sends the proximity service configuration data of the first user equipment to the first network-side entity according to the second request message.

Based on the third aspect or any one of the first to the third possible implementation manners of the third aspect, in a fifth possible implementation manner, the first request message further includes identity information of second user equipment, and the first user equipment and the second user equipment do not belong to a same PLMN; and the determining module is further configured to determine, at least according to the acquired proximity service configuration data of the first user equipment, that the first user equipment can perform a cross-PLMN proximity service corresponding to the application identifier.

According to a fourth aspect, user equipment is provided, including a sending module configured to send a first request message to a first network-side entity, where the first request message includes identity information of the first user equipment and an application identifier, such that the first network-side entity determines, at least according to acquired proximity service configuration data of the first user equipment, that the first user equipment can perform a proximity service corresponding to the application identifier; and a processing module configured to, after the first network-side entity determines that the first user equipment can perform the proximity service corresponding to the application identifier, perform the proximity service corresponding to the application identifier.

Based on the fourth aspect, in a first possible implementation manner, the proximity service configuration data of the first user equipment includes one or more of the following: whether the first user equipment is allowed to discover, be discovered, perform proximity service communication, a range of proximity service communication of the first user equipment, whether the first user equipment is allowed to perform a proximity service across a PLMN, whether the first user equipment is allowed to perform a proximity service in a VPLMN, and whether the first user equipment is allowed to perform a public safety proximity service. The range of proximity service communication of the first user equipment includes an identifier of an application, of the first user equipment, that can use a proximity service.

According to a fifth aspect, a proximity service authorization system is provided, including the user equipment according to the fourth aspect and the first network-side entity according to the third aspect.

In the present disclosure, when receiving a request message sent by first user equipment, a first network-side entity determines, at least according to acquired proximity service configuration data of the first user equipment, that the first user equipment can perform a proximity service corresponding to an application identifier. Therefore, a network-side entity can properly control a proximity service initiated by user equipment, and service quality of the proximity service of the user equipment can be ensured.

### BRIEF DESCRIPTION OF DRAWINGS

To describe the technical solutions in the embodiments of the present disclosure more clearly, the following briefly introduces the accompanying drawings required for describing the embodiments. The accompanying drawings in the following description show some embodiments of the present disclosure, and persons of ordinary skill in the art may still derive other drawings from these accompanying drawings without creative efforts.

FIG. 1 is a schematic flowchart of a proximity service authorization method according to an embodiment of the present disclosure;

FIG. 2 is a schematic flowchart of a proximity service authorization method according to another embodiment of the present disclosure;

FIG. 3 is a signaling diagram of a proximity service authorization method according to another embodiment of the present disclosure;

FIG. 4 is a signaling diagram of a proximity service authorization method according to another embodiment of the present disclosure;

FIG. 5 is a schematic structural diagram of a first network-side entity according to another embodiment of the present disclosure;

FIG. 6 is a schematic structural diagram of user equipment according to another embodiment of the present disclosure;

FIG. 7 is a schematic structural diagram of a first network-side entity according to another embodiment of the present disclosure;

FIG. 8 is a schematic structural diagram of user equipment according to another embodiment of the present disclosure; and

FIG. 9 is a schematic structural diagram of a proximity service authorization system according to another embodiment of the present disclosure.

### DESCRIPTION OF EMBODIMENTS

To make the objectives, technical solutions, and advantages of the embodiments of the present disclosure clearer, the following clearly describes the technical solutions in the embodiments of the present disclosure with reference to the accompanying drawings in the embodiments of the present disclosure. The described embodiments are some but not all of the embodiments of the present disclosure. All other embodiments obtained by persons of ordinary skill in the art based on the embodiments of the present disclosure without creative efforts shall fall within the protection scope of the present disclosure.

In an existing proximity service authorization method, a proximity service server does not need to authorize and authenticate user equipment using a proximity service. As a result, the proximity service server cannot properly control a proximity service of user equipment of a mobile terminal, and therefore, service quality of the proximity service of the user equipment cannot be ensured. The proximity service server is an entity for controlling a ProSe service, and may have another name, such as a proximity service control function (PSCF), which is not limited in the present disclosure.

Further, in the existing proximity service authorization method, proximity service authorization can be performed on two user equipment that need to directly perform data communication only when the two user equipment are located in a same PLMN. When two user equipment that need to directly perform data communication are located in different PLMNs, proximity service authorization cannot be performed on the two user equipment. Therefore, an application limitation exists.

In view of the problem existing in the prior art, the present disclosure provides a proximity service authorization method, which can resolve the following problem in an existing proximity service implementation method. Because a proximity service server does not need to authorize and authenticate user equipment using a proximity service, the proximity service server cannot properly control a proximity service of user equipment of a mobile terminal, and therefore, service quality of the proximity service of the user equipment cannot be ensured. Moreover, when two user equipment that need to directly perform data communication are located in different PLMNs, proximity service authorization can still be performed on the two user equipment, which extends an application scope of the existing proximity service authorization method.

The technical solutions of the present disclosure may be applied to various wireless communications systems, such as a Global System for Mobile Communications (GSM) system, a general packet radio service (GPRS) system, a Code Division Multiple Access (CDMA) system, a CDMA2000 system, a Wideband Code Division Multiple Access (WCDMA) system, a Long Term Evolution (LTE) system, or a Worldwide Interoperability for Microwave Access (WiMAX) system.

It should be noted that a network-side entity in the embodiments of the present disclosure includes a ProSe Server, a mobility management entity (MME), or a home subscriber server (HSS).

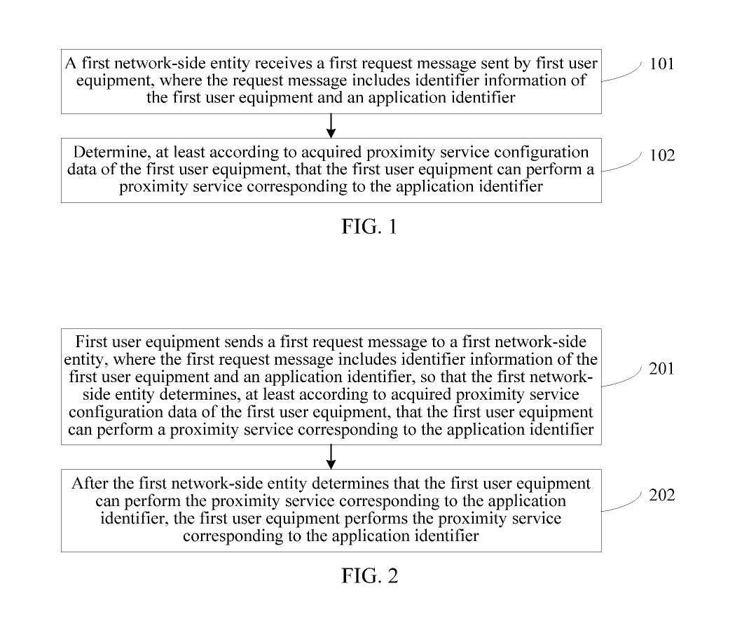

FIG. 1 is a schematic flowchart of a proximity service authorization method according to an embodiment of the present disclosure. As shown in FIG. 1, the proximity service authorization method in this embodiment may include the following steps.

101: A first network-side entity receives a first request message sent by first user equipment, where the request message includes identity information of the first user equipment and an application identifier.

The first request message may be, for example, a discovery request (device discovery request) message, and the request message includes the identity information of the first user equipment and the application identifier. In an actual application, the request message further includes identity information of second user equipment. The first user equipment is discovering user equipment, and the second user equipment is discovered user equipment.

The identity information of the first user equipment includes, for example, a proximity service identifier registered with a corresponding network-side entity by the first user equipment, and an identifier of a PLMN in which the first user equipment is located, such as an international mobile subscriber identity (IMSI) or a globally unique temporary identity (GUTI).

The identity information of the second user equipment includes, for example, a proximity service identifier registered with a corresponding network-side entity by the second user equipment and an identity of a PLMN in which the second user equipment is located, such as an IMSI or a GUTI.

102: Determine, at least according to acquired proximity service configuration data of the first user equipment, that the first user equipment can perform a proximity service corresponding to the application identifier.

The proximity service configuration data of the first user equipment includes one or more of the following: whether the first user equipment is allowed to discover, be discovered, to perform proximity service communication, a range of proximity service communication of the first user equipment, whether the first user equipment is allowed to perform a proximity service across a PLMN, whether the first user equipment is allowed to perform a proximity service in a VPLMN, and whether the first user equipment is allowed to perform a public safety proximity service. The configuration data described in the present disclosure is data used for performing authorization on a proximity service, and includes a user preference and/or subscription data, and the like, and the configuration data is only a generalization.

In an optional implementation manner of the present disclosure, the acquiring proximity service configuration data of the first user equipment includes receiving, by the first network-side entity, first information sent by the first user equipment, where the first information includes one or more of the following: whether the first user equipment is allowed to discover, be discovered, perform proximity service communication, and a range of proximity service communication of the first user equipment.

In an optional implementation manner of the present disclosure, the acquiring proximity service configuration data of the first user equipment includes receiving, by the first network-side entity, second information of a first user equipment sent by a second network-side entity, where the second information includes one or more of the following: whether the first user equipment is allowed to discover, be discovered, perform proximity service communication, a range of proximity service communication of the first user equipment, whether the first user equipment is allowed to perform a proximity service across a PLMN, whether the first user equipment is allowed to perform a proximity service in a VPLMN, and whether the first user equipment is allowed to perform a public safety proximity service.

For example, the range of proximity service communication of the first user equipment includes an identifier of an application, of the first user equipment, that can use a proximity service, such as an application identifier or another identifier that can be mapped as the application identifier.

In an optional implementation manner of the present disclosure, if the first user equipment is allowed to perform a proximity service in a VPLMN, and the first network-side entity is a network-side entity of the VPLMN, the acquiring proximity service configuration data of the first user equipment includes sending, by the first network-side entity, a second request message to a third network-side entity, where the second request message includes the identity information of the first user equipment, such that the third network-side entity sends the proximity service configuration data of the first user equipment to the first network-side entity according to the second request message.

In an optional implementation manner of the present disclosure, the first request message further includes the identity information of the second user equipment, and the first user equipment and the second user equipment do not belong to a same PLMN; and after the receiving, by a first network-side entity, a first request message sent by first user equipment, further includes determining, by the first network-side entity at least according to the acquired proximity service configuration data of the first user equipment, that the first user equipment can perform a cross-PLMN proximity service corresponding to the application identifier.

In this embodiment of the present disclosure, when receiving a request message sent by first user equipment, a first network-side entity determines, at least according to acquired proximity service configuration data of the first user equipment, that the first user equipment can perform a proximity service corresponding to an application identifier. Therefore, a network-side entity can properly control a proximity service initiated by user equipment, and service quality of the proximity service of the user equipment can be ensured.

Further, when two user equipment are located in different PLMNs, a network-side entity can also implement proper authorization control on a cross-PLMN proximity service initiated by the user equipment, which extends an application scope of an existing proximity service authorization method.

FIG. 2 is a schematic flowchart of a proximity service authorization method according to another embodiment of the present disclosure. As shown in FIG. 2, the method includes the following steps.

201: First user equipment sends a first request message to a first network-side entity, where the first request message includes identity information of the first user equipment and an application identifier, such that the first network-side entity determines, at least according to acquired proximity service configuration data of the first user equipment, that the first user equipment can perform a proximity service corresponding to the application identifier.

The first request message may be, for example, a discovery request (device discovery request) message, and the first request message includes the identity information of the first user equipment and the application identifier. In an actual application, the request message further includes identity information of second user equipment. The first user equipment is discovering user equipment, and the second user equipment is discovered user equipment.

The identity information of the first user equipment includes, for example, a proximity service identifier registered with a corresponding network-side entity by the first user equipment and an identifier of a PLMN in which the first user equipment is located. The identity information of the second user equipment includes, for example, a proximity service identifier registered with a corresponding network-side entity by the second user equipment and an identity of a PLMN in which the second user equipment is located.

It should be noted that, for implementation of the determining, by the first network-side entity at least according to acquired proximity service configuration data of the first user equipment, that the first user equipment can perform a proximity service corresponding to the application identifier, reference may be made to related descriptions in the embodiment shown in FIG. 1, and details are not provided herein again.

The proximity service configuration data of the first user equipment includes one or more of the following: whether the first user equipment is allowed to discover, be discovered, perform proximity service communication, a range of proximity service communication of the first user equipment, whether the first user equipment is allowed to perform a proximity service across a PLMN, whether the first user equipment is allowed to perform a proximity service in a VPLMN, and whether the first user equipment is allowed to perform a public safety proximity service. The range of proximity service communication of the first user equipment includes an identifier of an application, of the first user equipment, that can use a proximity service.

202: After the first network-side entity determines that the first user equipment can perform the proximity service corresponding to the application identifier, the first user equipment performs the proximity service corresponding to the application identifier.

In this embodiment of the present disclosure, when receiving a request message sent by first user equipment, a first network-side entity determines, at least according to acquired proximity service configuration data of the first user equipment, that the first user equipment can perform a proximity service corresponding to an application identifier. Therefore, a network-side entity can properly control a proximity service initiated by user equipment, and service quality of the proximity service of the user equipment can be ensured.

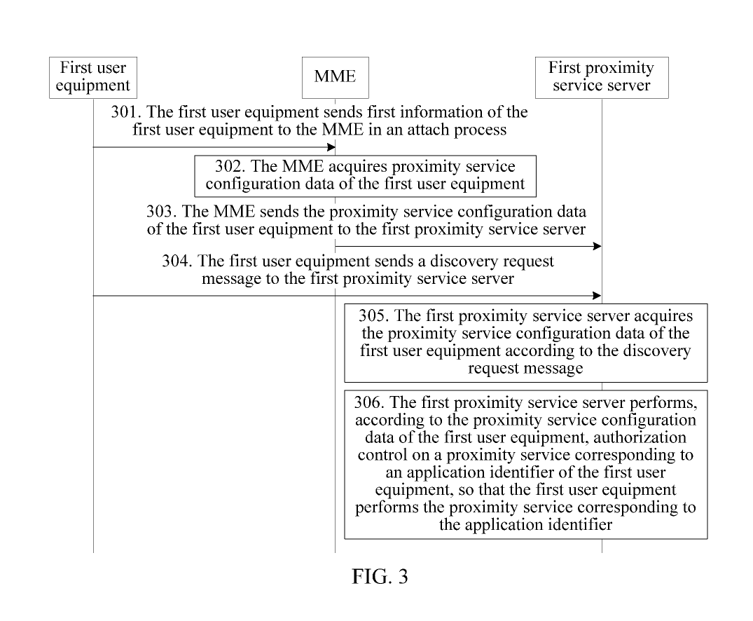

FIG. 3 is a signaling diagram of a proximity service authorization method according to another embodiment of the present disclosure. It is assumed that first user equipment and second user equipment are located in a same PLMN, a proximity service server corresponding to the first user equipment is a first proximity service server, a core network entity corresponding to the first user equipment is an MME, and proximity service configuration data of the first user equipment is saved in an HSS. The proximity service authorization method in this embodiment is shown in FIG. 3, and includes the following steps.

301: The first user equipment sends first information of the first user equipment to the MME in an attach process.

The first information of the first user equipment may be, for example, proximity service capability information of the first user equipment, and in an implementation, the first user equipment sends an attach request message to the MME, where the proximity service capability information of the first user equipment is carried in the attach request message. The proximity service capability information of the first user equipment indicates whether the first user equipment supports a common proximity service (common ProSe) and a public safety service. The proximity service capability information of the first user equipment includes identity information of the first user equipment. The identity information is, for example, an IMSI or a temporary identifier of user equipment (GUTI). The proximity service capability information of the first user equipment may further include one or more of activating (activate) and/or deactivating (deactivate), discovery (discover), being discovered (discoverable), or proximity service communication (ProSe communication). Then, the MME may save the proximity service capability information of the first user equipment in a proximity service configuration data entry corresponding to the identity information of the first user equipment.

302: The MME acquires the proximity service configuration data of the first user equipment.

In an implementation, assuming that, after the first user equipment is attached to the MME last time, the proximity service configuration data of the first user equipment changes, or the MME has no proximity service configuration data of the first user equipment, that is, when the MME queries, according to the identity information of the first user equipment, the proximity service configuration data entry corresponding to the identity information of the first user equipment, and no proximity service configuration data corresponding to the identity information of the first user equipment exists, the MME may send an update location request message to the HSS of the first user equipment. The HSS returns an update location acknowledgement (Update Location Ack) message to the MME, where the proximity service configuration data of the first user equipment is carried in the Update Location Ack message. Then, the MME may save the proximity service configuration data of the first user equipment in the proximity service configuration data entry corresponding to the identity information of the first user equipment.

The proximity service configuration data of the first user equipment includes, for example, one or more of the following: whether the first user equipment is allowed to discover, be discovered, perform proximity service communication, and a range of proximity service communication of the first user equipment. The proximity service configuration data of the first user equipment may further include, for example, one or more of the following: whether the first user equipment is allowed to perform a proximity service across a PLMN, whether the first user equipment is allowed to perform a proximity service in a VPLMN, and whether the first user equipment is allowed to perform a public safety proximity service.

303: The MME sends the proximity service configuration data of the first user equipment to the first proximity service server.

In an implementation, the MME may send the proximity service configuration data of the first user equipment to the first proximity service server using an update proximity service information (Update ProSe info request) message. After the proximity service configuration data of the first user equipment changes, the MME may also send updated proximity service configuration data of the first user equipment to the first proximity service server using the Update ProSe info request message. Then, the first proximity service server may save the proximity service configuration data of the first user equipment in a proximity service configuration data entry corresponding to the identity information of the first user equipment.

Optionally, after receiving the Update ProSe info request message, the first proximity service server may send an update proximity service information acknowledgement (Update ProSe info Ack) message to the MME.

304: The first user equipment sends a discovery request message to the first proximity service server.

When an application of the first user equipment needs to perform a proximity service, the first user equipment may send a discovery request message to the first proximity service server, where the discovery request message includes the identity information of the first user equipment and an application identifier. In an actual application, in order to discover the second user equipment, the discovery request message further includes identity information of the second user equipment.

305: The first proximity service server acquires the proximity service configuration data of the first user equipment according to the discovery request message.

For example, after receiving the discovery request message sent by the first user equipment, the first proximity service server may query, according to the identity information of the first user equipment that is included in the discovery request message, the proximity service configuration data entry corresponding to the identity information of the first user equipment, to acquire the proximity service configuration data of the first user equipment.

306: The first proximity service server performs, according to the proximity service configuration data of the first user equipment, authorization control on a proximity service corresponding to an application identifier of the first user equipment, such that the first user equipment performs the proximity service corresponding to the application identifier.

For example, it is assumed that it is determined, according to the proximity service configuration data of the first user equipment, that the first user equipment has a discovering capability. Because the first user equipment and the second user equipment are located in a same PLMN in this embodiment, a network-side entity may also acquire proximity service configuration data of the second user equipment according to the identity information of the second user equipment that is included in the discovery request message. If it is determined that the second user equipment has a capability of being discovered, and further, according to the proximity service configuration data of the first user equipment and the proximity service configuration data of the second user equipment, if both the proximity service configuration data of the first user equipment and the proximity service configuration data of the second user equipment include the application identifier, it may be determined that the proximity service corresponding to the application identifier may be performed between the first user equipment and the second user equipment.

Then, the first proximity service server triggers the second user equipment to broadcast a proximity service code of the second user equipment, and the first proximity service server sends the proximity service code, which is learned by broadcasting, of the second user equipment to the first user equipment. The first user equipment performs the proximity service corresponding to the application identifier between the first user equipment and the second user equipment using the proximity service code of the second user equipment.

In this embodiment of the present disclosure, when receiving a request message sent by first user equipment, a network-side entity acquires proximity service configuration data of the first user equipment according to identity information of the first user equipment that is included in the request message, and performs, according to the proximity service configuration data of the first user equipment, authorization control on a proximity service corresponding to an application identifier of the first user equipment, such that the first user equipment performs the proximity service corresponding to the application identifier. Therefore, a network-side entity can properly control a proximity service initiated by user equipment, and service quality of the proximity service of the user equipment can be ensured.

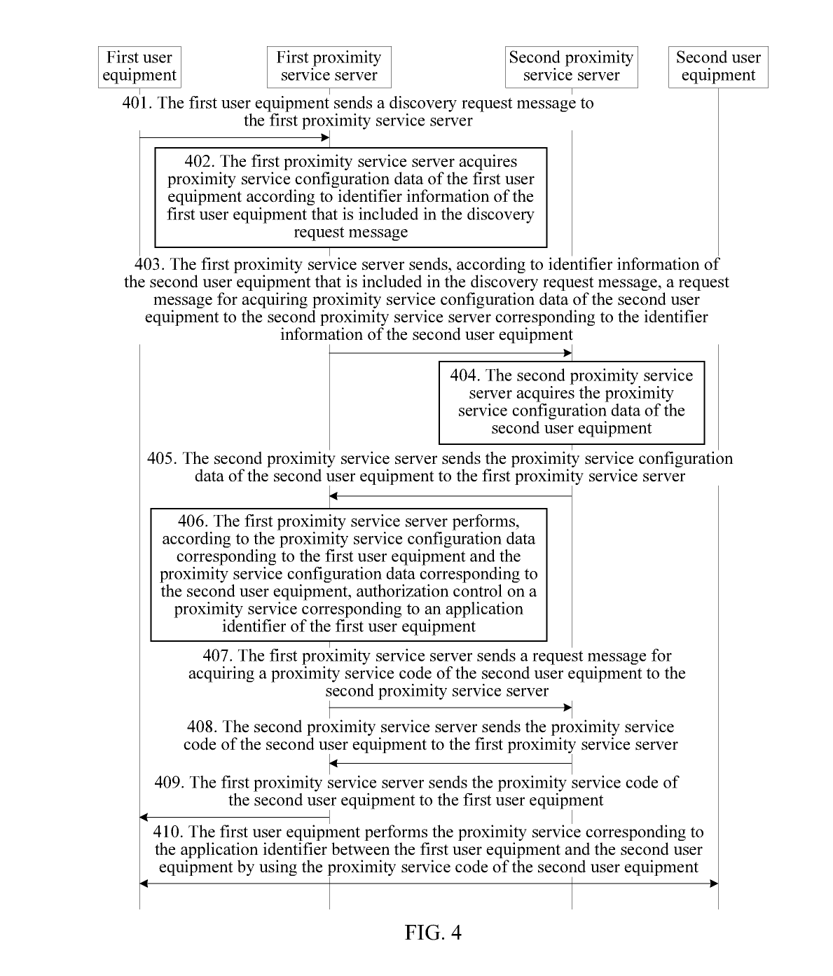

FIG. 4 is a signaling diagram of a proximity service authorization method according to another embodiment of the present disclosure. It is assumed that first user equipment and second user equipment are located in different PLMNs, a proximity service server corresponding to the first user equipment is a first proximity service server, and a proximity service server corresponding to the second user equipment is a second proximity service server. As shown in FIG. 4, the proximity service authorization method in this embodiment includes the following steps.

401: The first user equipment sends a discovery request message to the first proximity service server.

When an application of the first user equipment needs to perform a proximity service, the first user equipment may send a discovery request message to the first proximity service server, where the discovery request message includes identity information of the first user equipment and an application identifier. In an actual application, in order to discover the second user equipment, the discovery request message further includes identity information of the second user equipment.

The identity information of the first user equipment includes an identity of a PLMN in which the first user equipment is located; the identity information of the second user equipment includes an identity of a PLMN in which the second user equipment is located.

402: The first proximity service server acquires proximity service configuration data of the first user equipment according to identity information of the first user equipment that is included in the discovery request message.

For example, before step 401, the first proximity service server acquires the proximity service configuration data of the first user equipment from an MME of the first user equipment or an HSS of the first user equipment. For an implementation, reference may be made to related descriptions in step 302 and step 303 in the embodiment shown in FIG. 3, and details are not provided again. The first proximity service server may save the acquired proximity service configuration data of the first user equipment in a proximity service configuration data entry corresponding to the identity information of the first user equipment.

After receiving the discovery request message sent by the first user equipment, the first proximity service server may query, according to the identity information of the first user equipment that is included in the discovery request message, the proximity service configuration data entry corresponding to the identity information of the first user equipment, to acquire the proximity service configuration data of the first user equipment.

The proximity service configuration data of the first user equipment includes, for example, one or more of the following: whether the first user equipment is allowed to discover, be discovered, perform proximity service communication, and a range of proximity service communication of the first user equipment. The proximity service configuration data of the first user equipment may further include, for example, one or more of the following: whether the first user equipment is allowed to perform a proximity service across a PLMN, whether the first user equipment is allowed to perform a proximity service in a VPLMN, and whether the first user equipment is allowed to perform a public safety proximity service.

403: The first proximity service server sends, according to identity information of the second user equipment that is included in the discovery request message, a request message for acquiring proximity service configuration data of the second user equipment to the second proximity service server corresponding to the identity information of the second user equipment.

In an implementation, after receiving the discovery request message sent by the first user equipment, the first proximity service server may determine, according to the identity information of the first user equipment and the identity information of the second user equipment that are included in the discovery request message, where it is assumed that the identity information corresponding to the first user equipment and the identity information corresponding to the second user equipment respectively include an identifier of a network in which the first user equipment is located and an identifier of a network in which the second user equipment is located (such as identifiers of PLMNs), that the first user equipment and the second user equipment are not located in a same PLMN. In this case, the first proximity service server sends the request message for acquiring the proximity service configuration data of the second user equipment to the second proximity service server using the discovery request (device discovery request) message and according to the identity information of the second user equipment.

404: The second proximity service server acquires the proximity service configuration data of the second user equipment.

For example, the second proximity service server acquires the proximity service configuration data of the second user equipment from an MME of the second user equipment or an HSS of the second user equipment. For an implementation, reference may be made to related descriptions in step 302 and step 303 in the embodiment shown in FIG. 3, and details are not provided again. The second proximity service server may save the acquired proximity service configuration data of the second user equipment in a proximity service configuration data entry corresponding to the identity information of the second user equipment.

After receiving the request message, which is sent by the first proximity service server, for acquiring the proximity service configuration data of the second user equipment, the second proximity service server queries, according to the identity information of the second user equipment that is included in the request message, the proximity service configuration data entry corresponding to the identity information of the second user equipment, to acquire the proximity service configuration data of the second user equipment.

The proximity service configuration data of the second user equipment includes, for example, one or more of the following: whether the second user equipment is allowed to discover, be discovered, perform proximity service communication, and a range of proximity service communication of the second user equipment. The proximity service configuration data of the second user equipment may further include, for example, one or more of the following: whether the second user equipment is allowed to perform a proximity service across a PLMN, whether the second user equipment is allowed to perform a proximity service in a VPLMN, and whether the second user equipment is allowed to perform a public safety proximity service.

405: The second proximity service server sends the proximity service configuration data of the second user equipment to the first proximity service server.

406: The first proximity service server performs, according to the proximity service configuration data corresponding to the first user equipment and the proximity service configuration data corresponding to the second user equipment, authorization control on a proximity service corresponding to an application identifier of the first user equipment.

For example, if it is determined, according to the proximity service configuration data of the first user equipment, that the first user equipment has a capability of discovering across a PLMN, and it is determined, according to the proximity service configuration data of the second user equipment, that the second user equipment has a capability of being discovered across a PLMN, and further, according to the proximity service configuration data of the first user equipment and the proximity service configuration data of the second user equipment, if it is assumed that both the proximity service configuration data of the first user equipment and the proximity service configuration data of the second user equipment include the application identifier, then, it may be determined that the proximity service corresponding to the application identifier may be performed between the first user equipment and the second user equipment.

407: The first proximity service server sends a request message for acquiring a proximity service code of the second user equipment to the second proximity service server.

Because the first user equipment and the second user equipment are not located in the same PLMN, after it is determined that the proximity service corresponding to the application identifier may be performed between the first user equipment and the second user equipment across a PLMN, the first proximity service server sends the request message for acquiring the proximity service code of the second user equipment to the second proximity service server according to the identity information of the second user equipment.

408: The second proximity service server sends the proximity service code of the second user equipment to the first proximity service server.

In an embodiment, the second proximity service server triggers the second user equipment to broadcast the proximity service code of the second user equipment, and the second proximity service server sends the proximity service code, which is learned by broadcasting, of the second user equipment to the first proximity service server.

409: The first proximity service server sends the proximity service code of the second user equipment to the first user equipment.

410: The first user equipment performs the proximity service corresponding to the application identifier between the first user equipment and the second user equipment using the proximity service code of the second user equipment.

In this embodiment of the present disclosure, when two user equipment that need to directly perform a proximity service are located in different PLMNs, a first proximity service server may acquire proximity service configuration data and a proximity service key of second user equipment using a second proximity service server corresponding to the second user equipment, such that authorization control may be performed on a proximity service between the two user equipment located in different PLMNs, which extends an application scope of an existing proximity service authorization method.

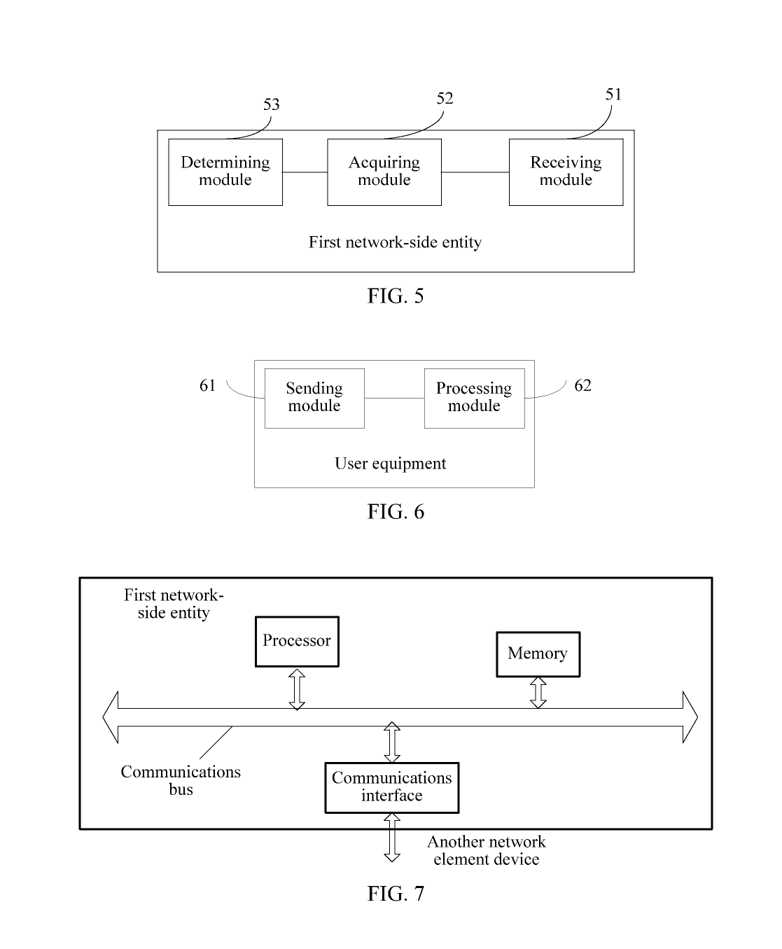

FIG. 5 is a schematic structural diagram of a first network-side entity according to another embodiment of the present disclosure. As shown in FIG. 5, the first network-side entity includes a receiving module 51 configured to receive a first request message sent by first user equipment, where the first request message includes identity information of the first user equipment and an application identifier; an acquiring module 52 configured to acquire proximity service configuration data of the first user equipment; and a determining module 53 configured to determine, at least according to the acquired proximity service configuration data of the first user equipment, that the first user equipment can perform a proximity service corresponding to the application identifier.

For example, the acquiring module 52 is configured to receive first information sent by the first user equipment, where the first information includes one or more of the following: whether the first user equipment is allowed to discover, be discovered, perform proximity service communication, and a range of proximity service communication of the first user equipment.

For another example, the acquiring module 52 is further configured to receive second information of a first user equipment sent by a second network-side entity, where the second information includes one or more of the following: whether the first user equipment is allowed to discover, be discovered, perform proximity service communication, a range of proximity service communication of the first user equipment, whether the first user equipment is allowed to perform a proximity service across a PLMN, whether the first user equipment is allowed to perform a proximity service in a VPLMN, and whether the first user equipment is allowed to perform a public safety proximity service.

For example, the range of proximity service communication of the first user equipment includes an identifier of an application, of the first user equipment, that can use a proximity service.

For example, the first user equipment is allowed to perform a proximity service in a VPLMN, and the first network-side entity is a network-side entity of the VPLMN. The acquiring module 52 is configured to send a second request message to a third network-side entity, where the second request message includes the identity information of the first user equipment, such that the third network-side entity sends the proximity service configuration data of the first user equipment to the first network-side entity according to the second request message.

For example, the first request message further includes identity information of second user equipment, and the first user equipment and the second user equipment do not belong to a same PLMN; and the determining module 53 is further configured to determine, at least according to the acquired proximity service configuration data of the first user equipment, that the first user equipment can perform a cross-PLMN proximity service corresponding to the application identifier.

In this embodiment of the present disclosure, when receiving a request message sent by first user equipment, a first network-side entity determines, at least according to acquired proximity service configuration data of the first user equipment, that the first user equipment can perform a proximity service corresponding to an application identifier. Therefore, a network-side entity can properly control a proximity service initiated by user equipment, and service quality of the proximity service of the user equipment can be ensured.

Further, when two user equipment are located in different PLMNs, a network-side entity can also implement proper authorization control on a cross-PLMN proximity service initiated by the user equipment, which extends an application scope of an existing proximity service authorization method.

FIG. 6 is a schematic structural diagram of user equipment according to another embodiment of the present disclosure. As shown in FIG. 6, the user equipment includes a sending module 61 configured to send a first request message to a first network-side entity, where the first request message includes identity information of the first user equipment and an application identifier, such that the first network-side entity determines, at least according to acquired proximity service configuration data of the first user equipment, that the first user equipment can perform a proximity service corresponding to the application identifier; and a processing module 62 configured to, after the first network-side entity determines that the first user equipment can perform the proximity service corresponding to the application identifier, perform the proximity service corresponding to the application identifier.

The proximity service configuration data of the first user equipment includes one or more of the following: whether the first user equipment is allowed to discover, be discovered, perform proximity service communication, a range of proximity service communication of the first user equipment, whether the first user equipment is allowed to perform a proximity service across a PLMN, whether the first user equipment is allowed to perform a proximity service in a VPLMN, and whether the first user equipment is allowed to perform a public safety proximity service. The range of proximity service communication of the first user equipment includes an identifier of an application, of the first user equipment, that can use a proximity service.

In this embodiment of the present disclosure, when receiving a request message sent by first user equipment, a first network-side entity determines, at least according to acquired proximity service configuration data of the first user equipment, that the first user equipment can perform a proximity service corresponding to an application identifier. Therefore, a network-side entity can properly control a proximity service initiated by user equipment, and service quality of the proximity service of the user equipment can be ensured.

FIG. 7 is a schematic structural diagram of a first network-side entity according to another embodiment of the present disclosure. As shown in FIG. 7, the first network-side entity includes a processor, a memory, and a communications bus. The processor is connected to the memory by the communications bus, and the memory stores an instruction for implementing the proximity service authorization method. The first network-side entity further includes a communications interface, and the first network-side entity is in communication connection with another network element device (such as user equipment) using the communications interface.

When the processor invokes the instruction in the memory, the following steps may be performed: receiving a first request message sent by first user equipment, where the first request message includes identity information of the first user equipment and an application identifier; and determining, at least according to acquired proximity service configuration data of the first user equipment, that the first user equipment can perform a proximity service corresponding to the application identifier.

For example, the acquiring proximity service configuration data of the first user equipment includes receiving first information sent by the first user equipment, where the first information includes one or more of the following: whether the first user equipment is allowed to discover, be discovered, perform proximity service communication, and a range of proximity service communication of first user equipment.

For example, the acquiring proximity service configuration data of the first user equipment includes receiving second information of a first user equipment sent by a second network-side entity, where the second information includes one or more of the following: whether the first user equipment is allowed to discover, be discovered, perform proximity service communication, a range of proximity service communication of the first user equipment, whether the first user equipment is allowed to perform a proximity service across a PLMN, whether the first user equipment is allowed to perform a proximity service in a VPLMN, and whether the first user equipment is allowed to perform a public safety proximity service.

For example, the range of proximity service communication of the first user equipment includes an identifier of an application, of the first user equipment, that can use a proximity service.

For example, if the first user equipment is allowed to perform a proximity service in a VPLMN, and the first network-side entity is a network-side entity of the VPLMN, the acquiring proximity service configuration data of the first user equipment includes sending a second request message to a third network-side entity, where the second request message includes the identity information of the first user equipment, such that the third network-side entity sends the proximity service configuration data of the first user equipment to the first network-side entity according to the second request message.

For example, the first request message further includes identity information of second user equipment, and the first user equipment and the second user equipment do not belong to a same PLMN; and after the receiving a first request message sent by first user equipment, further includes determining, at least according to the acquired proximity service configuration data of the first user equipment, that the first user equipment can perform a cross-PLMN proximity service corresponding to the application identifier.

In this embodiment of the present disclosure, when receiving a request message sent by first user equipment, a first network-side entity determines, at least according to acquired proximity service configuration data of the first user equipment, that the first user equipment can perform a proximity service corresponding to an application identifier. Therefore, a network-side entity can properly control a proximity service initiated by user equipment, and service quality of the proximity service of the user equipment can be ensured.

Further, when two user equipment are located in different PLMNs, the first network-side entity can also implement proper authorization control on a cross-PLMN proximity service initiated by the user equipment, which extends an application scope of an existing proximity service authorization method.

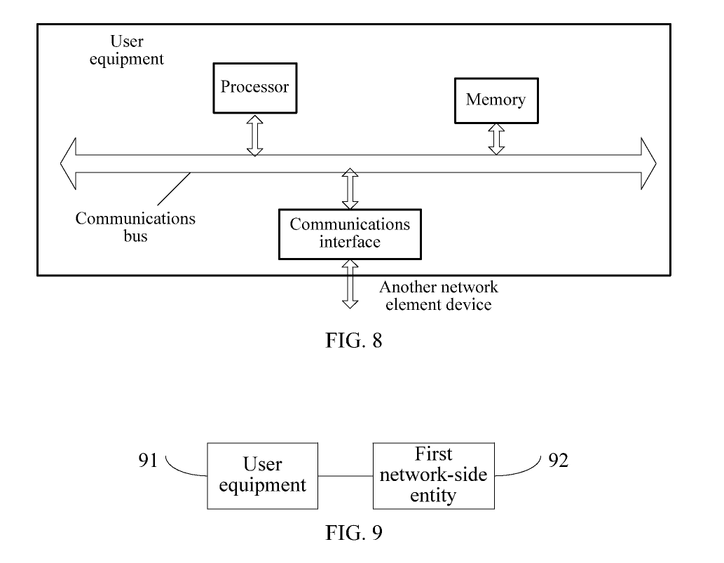

FIG. 8 is a schematic structural diagram of user equipment according to another embodiment of the present disclosure. As shown in FIG. 8, the user equipment includes a processor, a memory, and a communications bus. The processor is connected to the memory by the communications bus, and the memory stores an instruction for implementing the proximity service authorization method. The user equipment further includes a communications interface, and the user equipment is in communication connection with another network element device (such as a network-side entity) using the communications interface.

When the processor invokes the instruction in the memory, the following steps may be performed: sending a first request message to a first network-side entity, where the first request message includes identity information of the first user equipment and an application identifier, such that the first network-side entity determines, at least according to acquired proximity service configuration data of the first user equipment, that the first user equipment can perform a proximity service corresponding to the application identifier; and after the first network-side entity determines that the first user equipment can perform the proximity service corresponding to the application identifier, performing the proximity service corresponding to the application identifier.

The proximity service configuration data of the first user equipment includes one or more of the following: whether the first user equipment is allowed to discover, be discovered, perform proximity service communication, a range of proximity service communication of the first user equipment, whether the first user equipment is allowed to perform a proximity service across a PLMN, whether the first user equipment is allowed to perform a proximity service in a VPLMN, and whether the first user equipment is allowed to perform a public safety proximity service. The range of proximity service communication of the first user equipment includes an identifier of an application, of the first user equipment, that can use a proximity service.

In this embodiment of the present disclosure, when receiving a request message sent by first user equipment, a first network-side entity determines, at least according to acquired proximity service configuration data of the first user equipment, that the first user equipment can perform a proximity service corresponding to an application identifier. Therefore, a network-side entity can properly control a proximity service initiated by user equipment, and service quality of the proximity service of the user equipment can be ensured.

FIG. 9 is a schematic structural diagram of a proximity service authorization system according to another embodiment of the present disclosure. As shown in FIG. 9, the proximity service authorization system includes user equipment 91 and a first network-side entity 92, where the user equipment 91 is the user equipment according to the embodiment shown in FIG. 6 or FIG. 8, and details are not provided again; and the first network-side entity 92 is the network-side entity according to the embodiment shown in FIG. 5 or FIG. 7, and details are not provided again.

In the several embodiments provided in this application, it should be understood that the disclosed system, apparatus, and method may be implemented in other manners. For example, the described apparatus embodiment is merely exemplary. For example, the unit division is merely logical function division and may be other division in actual implementation. For example, multiple units or components may be combined or integrated into another system, or some features may be ignored or not performed. In addition, the displayed or discussed mutual couplings or direct couplings or communication connections may be implemented using some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on multiple network units. Some or all of the units may be selected according to actual needs to achieve the objectives of the solutions of the embodiments.

In addition, functional units in the embodiments of the present disclosure may be integrated into one processing unit, or each of the units may exist alone physically, or two or more units are integrated into one unit. The integrated unit may be implemented in a form of hardware, or may be implemented in a form of hardware in addition to a software functional unit.

When the foregoing integrated unit is implemented in a form of a software functional unit, the integrated unit may be stored in a form of code in a computer-readable storage medium. The code is stored in the computer-readable storage medium and includes several instructions for instructing a processor or a hardware circuit to perform all or some of the steps of the methods described in the embodiments of the present disclosure. The foregoing storage medium includes any medium that can store program code, such as a miniature high-capacity mobile storage disk, which needs no physical drive, a universal serial bus interface, a removable hard disk, a read-only memory (ROM), a random access memory (RAM), a magnetic disk, or an optical disc.

Finally, it should be noted that the foregoing embodiments are merely intended for describing the technical solutions of the present disclosure, rather than limiting the present disclosure. Although the present disclosure is described in detail with reference to the foregoing embodiments, persons of ordinary skill in the art should understand that they may still make modifications to the technical solutions described in the foregoing embodiments or make equivalent replacements to some technical features thereof, as long as such modifications or replacements do not cause the essence of corresponding technical solutions to depart from the protection scope of the technical solutions of the embodiments of the present disclosure.

What is claimed is:

1. A proximity service authorization method, comprising:
receiving, by a first network-side entity, a first request message sent by first user equipment, wherein the first request message comprises identity information of the first user equipment and an application identifier; and
determining, at least according to acquired proximity service configuration data of the first user equipment, that the first user equipment can perform a proximity service corresponding to the application identifier.

2. The method according to claim 1, wherein acquiring proximity service configuration data of the first user equipment comprises receiving, by the first network-side entity, second information of the first user equipment sent by a second network-side entity, and wherein the second information comprises one or more of the following: whether the first user equipment is allowed to discover, whether the first user equipment is allowed to be discovered, whether the first user equipment is allowed to perform proximity service communication, whether the first user equipment is allowed to perform a proximity service across a public land mobile network, whether the first user equipment is allowed to perform a proximity service in a visited public land mobile network (VPLMN), whether the first user equipment is allowed to perform a public safety proximity service, and a range of proximity service communication of the first user equipment.

3. The method according to claim 2, wherein the range of proximity service communication of the first user equipment comprises an identifier of an application, of the first user equipment, that can use a proximity service.

4. The method according to claim 1, wherein when the first user equipment is allowed to perform a proximity service in a visited public land mobile network (VPLMN) and the first network-side entity is a network-side entity of the VPLMN, acquiring the proximity service configuration data of the first user equipment comprises sending, by the first network-side entity, a second request message to a third network-side entity, and wherein the second request message comprises the identity information of the first user equipment, such that the third network-side entity sends the proximity service configuration data of the first user equipment to the first network-side entity according to the second request message.

5. The method according to claim 1, wherein the first request message further comprises identity information of second user equipment, wherein the first user equipment and the second user equipment do not belong to a same public land mobile network (PLMN), and wherein after receiving, by the first network-side entity, the first request message sent by the first user equipment, the method further comprises determining, by the first network-side entity at least according to the acquired proximity service configuration data of the first user equipment, that the first user equipment can perform a cross-PLMN proximity service corresponding to the application identifier.

6. A first network-side entity, comprising:
a memory configured to store a program; and
a processor coupled to the memory, wherein the processor is configured to cause the first network-side entity to:
receive a first request message sent by first user equipment, wherein the first request message comprises identity information of the first user equipment and an application identifier;
acquire proximity service configuration data of the first user equipment; and
determine, at least according to the acquired proximity service configuration data of the first user equipment, that the first user equipment can perform a proximity service corresponding to the application identifier.

7. The first network-side entity according to claim 6, wherein the first network-side entity is further configured to receive second information of the first user equipment sent by a second network-side entity, and wherein the second information comprises one or more of the following:
whether the first user equipment is allowed to discover, whether the first user equipment is allowed to be discovered, whether the first user equipment is allowed to perform proximity service communication, whether the first user equipment is allowed to perform a proximity service across a public land mobile network, whether the first user equipment is allowed to perform a proximity service in a visited public land mobile network (VPLMN), whether the first user equipment is allowed to perform a public safety proximity service, and a range of proximity service communication of the first user equipment.

8. The first network-side entity according to claim 7, wherein the range of proximity service communication of the first user equipment comprises an identifier of an application, of the first user equipment, that can use a proximity service.

9. The first network-side entity according to claim 6, wherein when the first user equipment is allowed to perform a proximity service in a visited public land mobile network (VPLMN) and the first network-side entity is a network-side entity of the VPLMN, the first network-side entity is configured to send a second request message to a third network-side entity, and wherein the second request message comprises the identity information of the first user equipment, such that the third network-side entity sends the proximity service configuration data of the first user equipment to the first network-side entity according to the second request message.

10. The first network-side entity according to claim 6, wherein the first request message further comprises identity information of second user equipment, wherein the first user equipment and the second user equipment do not belong to a same public land mobile network (PLMN), and wherein the first network-side entity is further configured to determine, at least according to the acquired proximity service configuration data of the first user equipment, that the first user equipment can perform a cross-PLMN proximity service corresponding to the application identifier.

11. A user equipment, comprising:
a memory configured to store a program; and
a processor coupled to the memory, wherein the processor is configured to cause the user equipment to:
send a first request message to a first network-side entity, wherein the first request message comprises identity information of the user equipment and an application identifier, such that the first network-side entity determines, at least according to acquired proximity service configuration data of the user equipment, that the user equipment can perform a proximity service corresponding to the application identifier; and
perform the proximity service corresponding to the application identifier after the first network-side entity determines that the user equipment can perform the proximity service corresponding to the application identifier.

12. The user equipment according to claim 11, wherein the proximity service configuration data of the user equipment comprises one or more of the following: whether the user equipment is allowed to discover, whether the user equipment is allowed to be discovered, whether the user equipment is allowed to perform proximity service communication, whether the user equipment is allowed to perform a proximity service across a public land mobile network, whether the user equipment is allowed to perform a proximity service in a visited public land mobile network (VPLMN), whether the user equipment is allowed to perform a public safety proximity service, and a range of proximity service communication of the user equipment, and the range of proximity service communication of the user equipment comprises an identifier of an application, of the user equipment, that can use a proximity service.
